(19) United States
(12) Patent Application Publication
(10) Pub. No.: US 2002/0072395 A1
(43) Pub. Date: Jun. 13, 2002

(54) Telephone with fold out keyboard

(76) Inventor: Ivan Miramontes, Whittier, CA (US)

Correspondence Address: Jeffrey K. Seto, 617 Tinkerbell Rd., Chapel Hill, NC, 27514, US

(21) Appl. No.: 09/969,381

(22) Filed: Sep. 28, 2001

Related U.S. Application Data
(60) Provisional application No. 60/265,667, filed on Feb. 2, 2001.
(60) Provisional application No. 60/251,763, filed on Dec. 8, 2000.

(51) Int. Cl. H04B 1/38

(52) U.S. Cl. 455/566; 455/90

(57) ABSTRACT

An electronic device that has a lower portion that unfolds to reveal a full “qwerty” keyboard. When the keyboard (lower portion) is folded closed, a number pad is visible and the device looks similar to a traditional portable or cellular telephone. The device can be used as a personal digital assistant, a cellular telephone, a cordless telephone or as the handset of a traditional wire line telephone. The fold-out key board of the electronic device is used for easy entry of text data while a communication channel is active and for storing information on the device when communication channels are closed. The device includes two way messaging and Internet browsing capabilities. The full keyboard provides efficient text messaging which can be supplemented by word guessing software. Optionally, word processing applications can be used with the device giving the device many properties of a lap top computer. The full keyboard allows users to take full advantage of mobile applications such as Short Message Service (SMS) and other standardized mobile protocols such as SIM Application Toolkit and the Wireless Application Protocol (WAP). A graphical user interface is displayed on a screen that is fully visible when the keyboard is open and closed. The word guessing software can be used while the device is in either the open or closed position.

This application claims priority to Provisional Patent Application No. 60/265,667, filed on Feb. 2, 2001, entitled, “Swiss-Phone”, and to Provisional Patent Application No. 60/251,763, filed on Dec. 8, 2000, also entitled, “Swiss-Phone”.

### BACKGROUND OF THE INVENTION

The present invention relates generally to the field of telephones and more specifically to a telephone with a full fold out qwerty keyboard.

The first telephone was invented in 1876 by Alexander Graham Bell. The basic concept of transforming a human voice into an undulating current that is then used to reproduce the voice at a remote location is still in use today in some analog wire line systems. Advances in modern technology have added to the capabilities of the modern telephones. Today both voice and data can be carried over a telephone line and both may be in digital form. Moreover, a physical telephone line today is not even a requirement as radio waves can now be used to carry voice and data. Such radio waves are used in cordless telephones found in many of today's households and also make cellular telephone systems possible.

A basic telephone set contains a transmitter that transfers the caller's voice, a receiver that amplifies sound from an incoming call, a rotary or push-button dial and, a ringer or alerter. A small assembly of electrical parts, called the anti-sidetone network that keeps the caller's voice from sounding too loud through the receiver is also included. A speakerphone has a microphone and speaker in the base in addition to the transmitter and receiver in the handset. Speakerphones allow callers' hands to be free, and allow more than two people to listen and speak during a call. In a cordless phone, the handset cord is replaced by a radio link between the handset and base, but a line cord is still used between the base and the telephone line. This allows a caller to move about in a limited area while on the telephone. A cellular phone has miniaturized components that make it possible to combine the base and handset into one handheld unit. No line or handset cord is needed with a cellular phone thereby providing maximum mobility.

There are two common kinds of telephone transmitters: the carbon transmitter and the electret transmitter. The carbon transmitter is constructed by placing carbon granules between metal plates called electrodes. One of the metal plates is a thin diaphragm that takes variations in pressure caused by sound waves and transmits these variations to the carbon granules. The electrodes conduct electricity that flows through the carbon. Variations in pressure caused by sound waves hitting the diaphragm cause the electrical resistance of the carbon to vary—when the grains are squeezed together, they conduct electricity more easily; and when they are far apart, they conduct electricity less efficiently. The resultant current varies with the sound-wave pressure applied to the transmitter. The electret transmitter is composed of a thin disk of metal-coated plastic and a thicker, hollow metal disk. In the handset, the plastic disk is held slightly above most of the metal disk. The plastic disk is electrically charged, and an electric field is created in the space where the disks do not touch. Sound waves from the caller's voice cause the plastic disk to vibrate, which changes the distance between the disks, and so changes the intensity of the electric field between them. The variations in the electric field are translated into variations of electric current, which travels across telephone lines. An amplifier using transistors is needed with an electret transmitter to obtain sufficiently strong variations of electric current.

The receiver of a telephone is made from a flat ring of magnetic material with a short cuff of the same material attached to the ring's outer rim. Underneath the magnetic ring and inside the magnetic cuff is a coil of wire through which electric current, representing the sounds from the distant telephone, flows. A thin diaphragm of magnetic material is suspended from the inside edges of the magnetic ring so it is positioned between the magnet and the coil. The magnetic field created by the magnet changes with the current in the coil and makes the diaphragm vibrate. The vibrating diaphragm creates sound waves that replicate the sounds that were transformed into electricity by the other person's transmitter.

The alerter in a telephone is usually called the ringer, because for most of the telephone's history, a bell was used to indicate a call. The alerter responds only to a special frequency of electricity that is sent by the exchange in response to the request for that telephone number. Creating an electronic replacement for the bell that can provide a pleasing yet attention-getting sound at a reasonable cost. For many people, the sound of a bell is still preferable to the sound of an electronic alerter. However, since a mechanical bell requires a certain amount of space in the telephone to be effective, smaller telephones mandate the use of electronic alerters.

Two forms of dialing exist within the telephone system: dial pulse from a rotary dial, and multifrequency tone, which is commonly called by its original trade name of Touch-Tone, from a push-button dial. The development of inexpensive and reliable amplification provided by the introduction of the transistor in the 1960s made practical the design of a dialing system based on the transmission of relatively low power tones instead of the higher-power dial pulses. Today most telephones have push buttons instead of a rotary dial. Touch-Tone is an optional service, and telephone companies still maintain the ability to receive pulse dialing. Push-button telephones usually have a switch on the base that the customer can set to determine whether the telephone will send pulses or tones.

A cellular telephone is designed to give the user maximum freedom of movement while using a telephone. A cellular telephone uses radio signals to communicate between the “cell phone” and a base station, via an antenna. The served area is divided into cells something like a honeycomb, and an antenna is placed within each cell and connected by telephone lines to one exchange devoted to cellular-telephone calls. This exchange connects cellular telephones to one another and transfers the call to a regular exchange, public switched telephone network, if the call is between a cellular telephone and a non-cellular telephone. The special cellular exchange, through computer control, selects the antenna closest to the telephone when service is requested. As the telephone roams, the exchange automatically determines when to change the serving cell based on the power of the radio signal received simultaneously at adjacent sites. This change occurs without interrupting conversation. Practical power considerations limit the distance between the telephone and the nearest cellular antenna, and since cellular phones use radio signals, it is possible for unauthorized people to access communications carried out over cellular phones. One of the reasons why digital cell phones have gained in popularity, besides being able to access the Internet, is because their radio signals are harder to intercept and decode.

Analog transmission, in which speech or data is converted directly into a varying electrical current, is suitable for local calls. But once the call involves any significant distance, the necessary amplification of the analog signal can add so much noise that the received signal becomes unintelligible. For long-distance calls, the signal is digitized, or converted to a series of pulses that encodes the information. When an analog electrical signal is digitized, samples of the signal's strength are taken at regular intervals, usually about 8000 samples per second. Each sample is converted into a binary form, a number made up of a series of 1s and 0s. This number is easily and swiftly passed through the switching system. Digital transmission systems are much less subject to interfering noise than are analog systems. The digitized signal can then be passed through a digital-to-analog converter (DAC) at a point close to the receiving party, and converted to a form that the ear cannot distinguish from the original signal. There are several ways a digital or analog signal may be transmitted, including coaxial and fiber-optic cables and microwave and longwave radio signals sent along the ground or bounced off satellites in orbit around the earth. A coaxial wire, like the wire between a videocassette recorder (VCR) and a television set, is an efficient transmission system. A coaxial wire has a conducting tube surrounding another conductor. A coaxial cable contains several coaxial wires in a common outer covering. The important benefit of a coaxial cable over a cable composed of simple wires is that the coaxial cable is more efficient at carrying very high frequency currents. This is important because in providing transmission over long distances, many telephone conversations are combined using frequency-modulation (FM) techniques similar to the combining of many channels in the television system. The combined signal containing hundreds of individual telephone conversations is sent over one pair of wires in a coaxial cable, so the signal has to be very clear.

Fiber optic cable offer another telephone-transmission method that uses bundles of optical fibers, long strands of specially made glass encased in a protective coating. Optical fibers transmit energy in the form of light pulses. The technology is similar to that of the coaxial cable, except that the optical fibers can handle tens of thousands of conversations simultaneously. Another approach to long-distance transmission is the use of radio. Before coaxial cables were invented, very powerful longwave (low frequency) radio stations were used for intercontinental calls. Microwave radio uses very high frequency radio waves and has the ability to handle a large number of simultaneous conversations over the same microwave link. Because cable does not have to be installed between microwave towers, this system is usually cheaper than coaxial cable. On land, the coaxial-cable systems are often supplemented with microwave-radio systems. The technology of microwave radio is carried one step further by the use of communications satellites. Most communications satellites are in geosynchronous orbit—that is, they orbit the earth once a day over the equator, so the satellite is always above the same place on the earth's surface. That way, only a single satellite is needed for continuous service between two points on the surface, provided both points can be seen from the satellite. A combination of microwave, coaxial-cable, optical-fiber, and satellite paths now link the major cities of the world. The capacity of each type of system depends on its age and the territory covered, but capacities generally fall into the following ranges: Frequency modulation over a simple pair of wires like the earliest telephone lines yields tens of circuits (a circuit can transmit one telephone conversation) per pair; coaxial cable yields hundreds of circuits per pair of conductors, and thousands per cable; microwave and satellite transmissions yield thousands of circuits per link; and optical fiber has the potential for tens of thousands of circuits per fiber.

Computer-controlled exchange switches make it possible to offer a variety of extra services to both the residential and the business customer. Some services to which users may subscribe at extra cost are call waiting, in which a second incoming call, instead of receiving a busy signal, hears normal ringing while the subscriber hears a beep superimposed on the conversation in progress; and three-way calling, in which a second outgoing call may be placed while one is already in progress so that three subscribers can then talk to each other. Other services available to users are: caller ID, in which the calling party's number is displayed to the receiver on special equipment before the call is answered; and repeat dialing, in which a called number, if busy, will be automatically redialed for a certain amount of time. Of course users have the ability to block their name and phone from being displayed on a caller ID display. Another popular service is voice mail. While traditional answering machines cannot take a message if a caller is already on the line, voice mail creates a second virtual line. While a caller is talking to one party, a second incoming call is greeted with a message asking the second party to leave a message. The user will then be notified of the waiting message.

Unified messaging and the arrival of mobile Internet services means Short Message Service (SMS), a mobile messaging service, will soon become the primary alert mechanism for users to check and pick up their e-mail, fax or voice messages. The rapidly growing availability of WAP (Wireless Application Protocol) has enabled handsets to enhance the customer experience of reading and sending more messages. The arrival of the GSM (Global System for Mobile communications) family's next phase of evolution in the form of GPRS (General Packet Radio Services) will ensure faster speeds and boost the variety of mobile services available significantly. Mobile banking, M-Commerce, and customer service applications are also bolstering SMS traffic. The arrival of more advanced data services will yet again increase demand. During the First (1 G) and Second (2 G) Generations of mobile communications different regions of the world pursued different mobile phone standards. Europe pursued NMT and TACS for analog and GSM for digital. North America pursued AMPS for analog and a mix of TDMA, CDMA and GSM for digital. The Third Generation (3 G), based on CDMA technology, will bring these incompatible standards together and allow convergence toward a common standard for mobile multimedia.

It is an object of the present invention to enrich the user's experience of the mobile Internet by making text entry as simple as using a laptop keyboard. U.S. Pat. No. 5,337,346 issued to Uchikura describes an electronic device with a foldable keyboard however, the keyboard is only used for inputting data to the device while in an electronic notebook mode. Uchikura does not allow data that is entered via the keyboard to be transmitted outside the device. Currently there are about 30 billion text messages sent every month via wireless phones. This number is expected to double by December 2001. As mobile phones and computers converge towards unified handheld communication & computing devices, text messaging is becoming one of many ways in which text entry on handheld devices will be employed. Text entry is an integral part of the way users interact with computers in general and the Internet in particular. Simple text entry is required to query search engines, to send email or instant messages and to enter commands. The inadequacy of currently used methods for entering text is the major obstacle inhibiting the growth of a wireless web and other applications, such as, Microsoft's Pocket Word and Pocket Excel. A numeric keypad will always be a poor device for entering strings of text data. A QWERTY-style keyboard on a mobile device is needed to provide an easy to use text entry solution. Such a device will help the mobile Internet achieve its full commercial potential. An important feature of the present hand held electrical device is that data input through a full qwerty keyboard works in conjunction with wireless applications such as SMS, E-mail and web surfing.

### SUMMARY OF THE INVENTION

An electrical device for telephonic and data communications. The device is hand held and provides a user with text messaging and voice communications. The device comprises: a display screen for display text and graphical information, such as icons, pictures and video, to the user. At least one speaker is provided for transmitting audio information, such as voice and music, to the user. Navigational buttons control basic functions of the device, such as on/off, initiation and termination of a telephone call, and selection and activation of icons or other data displayed on the display screen. A number pad allows the user to input numeric and text data wherein the number pad is a primary input device of telephone number data. At least one microphone is provided for receiving audio data, such as voice, from the user. Device software provides a graphical user interface for the device and controls operation of hardware provided in the device. A communication control unit provides for transmission and reception of all data, voice, video, music and text from and to the device. A fold out section comprising approximately half of the portion of the device underneath the number pad unfolds in a direction perpendicular to a length of the device to reveal a full qwerty keyboard contained underneath the number pad. The keyboard being usable with applications on the device and providing the user with easy entry of text data.

The device can be used as a cellular telephone wherein the communication control unit includes an antenna that facilitates communication with a cellular base station. The device can also be used as a portable telephone in which case the communication control unit would include an antenna that facilitates communication with a portable telephone base that is connected, via a telephone line, to a public switched telephone network. Capabilities of the device include the use of short messaging service (SMS), receiving and inputting data from and to the Internet via a mobile browser, and wireless data transmission applications that are compatible with SIM Application Toolkit and Wireless Application Protocol (WAP). The device can also include a small built in camera that allows pictures and short videos to be sent from the device. Predictive text software is also provided and may be used when the device is in the open and closed positions.

### BRIEF DESCRIPTION OF THE DRAWINGS

The invention of the present application will now be described in more detail with reference to the accompanying drawings, given only by way of example, in which:

FIG. 1 is a frontal view of a preferred embodiment in the closed position;

FIG. 2 is a frontal view of a preferred embodiment in the open position;

FIG. 3 is a flow chart for initial user operation of a preferred embodiment;

FIG. 4 is a flow chart for telephone operations of a preferred embodiment;

FIG. 5 is a flow chart for Internet and messaging service operation of a preferred embodiment;

FIG. 6 is a schematic diagram for circuitry of a preferred embodiment; and, FIG. 7 is a frontal view of an alternative embodiment in the open position.

### DETAILED DESCRIPTION OF THE INVENTION

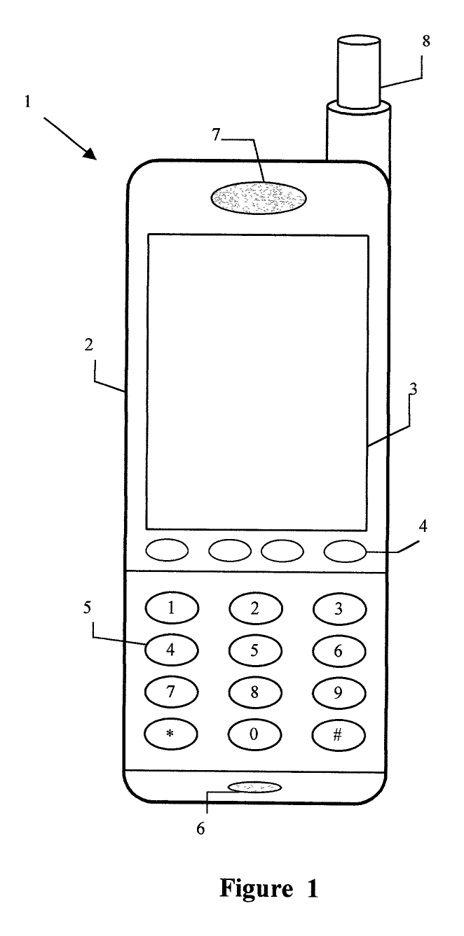

FIG. 1 shows a frontal view of a preferred embodiment wherein the qwerty keyboard is folded closed and hidden underneath number pad 5. Electrical device 1 comprises outer case 2, display screen 3, navigational buttons 4, number pad 5, microphone 6, speaker 7, and antenna 8. Outer case 2 defines a general size and shape of device 1. Other embodiments provide for alternative outer cases with varying sizes and shapes. Display screen 3 provides visual output to the user. Display output can be text and graphics; icons, pictures, and videos. Navigational buttons 4 allow the user to select options on a menu and activate various programs, such as telephone and text communications enabling programs, within device 1. In a preferred embodiment an arrow is provided on each of the navigational buttons, the arrows representing up, down, left, and right. The left and right buttons double as “Send” and “On/Off”, respectively. Other embodiments provide for inclusion of other control buttons, such as “Menu”, “Cancel”, “Home”, and “Select”, within the combination of navigation buttons. The number of navigational buttons may also be increased and decreased in alternative embodiments. Number pad 5 can be used as a traditional cellular or wire line telephone number pad. The numbers 0-9 are represented on a 3×4 keypad matrix with the star symbol, zero and the pound symbol residing on the bottom row of the matrix. The well known standard of three, or four, letters being represented on the number pads of 0 and 2-9 are included in the number pad 5. Microphone 6 is used to accept voice data from the user. Speaker 7 provides audio output to the user. In other embodiments, more than one microphone and/or speaker are provided. Such embodiments provide for the use of earphones and headsets. A popular “hands free” mode of operating wherein the speaker volume is greatly amplified can be realized with both one and two speakers. One alternative embodiment that utilizes two microphones and includes a camera is shown in FIG. 7, discussed herein after. Antenna 8 is used for radio communication between device I and a remote location such as a cellular telephone base station. Of course, if device 1 is used as the handset of a traditional wire line phone, then no antenna is required.

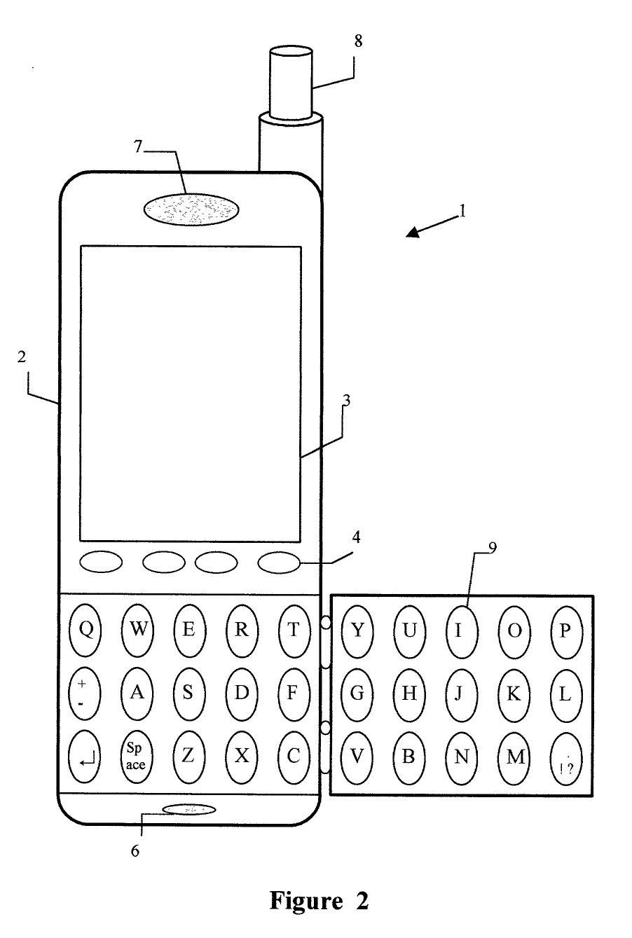

FIG. 2 shows electrical device 1 in the open position wherein the full qwerty keyboard 9 is ready to receive keystrokes. Like parts from FIG. 1 have retained like reference numbers. Still visible and ready for use while device 1 is in the open position are display 3, navigational buttons 4, microphone 6, speaker 7, and antenna 8. The only feature not visible is number pad 5, which is on the opposite side of the folded out portion, i.e., behind the right half of the keyboard. Keyboard 9 provides a pad for every letter in the alphabet plus four other pads, in this embodiment. More and less pads are provided in other embodiments. One of the extra pads, in this embodiment, contains the Return arrow. This button can be used as a Return button to break up lines of texts, for a new paragraph for example, during text messaging. It may also be used as an Enter button to select and activate a program. A second extra pad is the Space button that will commonly be required in text messaging. The last two extra buttons provide for plus and minus, and some punctuation marks. Other traditional keyboard pads can be provided and layering a second function on each key can also be used. In a preferred embodiment, the first five pads of the top two rows each provide a second function. These ten keys in the upper left hand corner of the qwerty keyboard can also act as the numbers 0-9, when a function key or icon is pressed or selected.

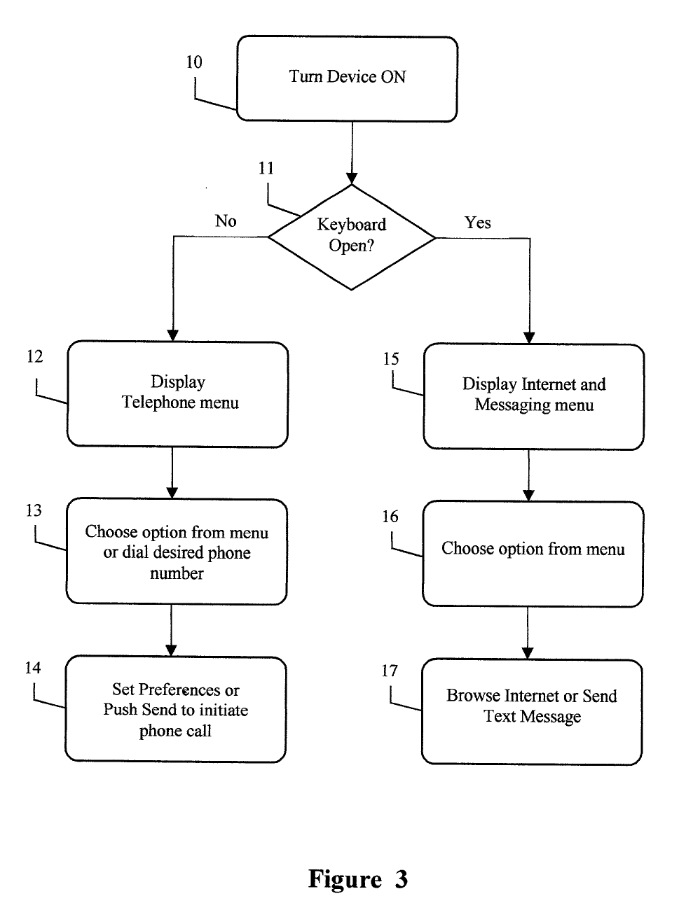

FIG. 3 is a general flow chart of user initial operation of the present device. If the device is off when the user wants to use it, the first thing the user does is to turn the device on, step 10, using the on/off button. In the embodiment shown in FIGS. 1 and 2, the on/off button is the far right navigational button. The navigational buttons 4 can be accessed and are fully operation both when the device is in the closed and open positions. When the device is initially turned on, or awakened from a power saving mode, the device determines whether or not the qwerty keyboard is open, step 11. The position of the qwerty keyboard determines the menu, consisting of text and graphics, to initially be displayed. If the qwerty keyboard is closed, step 12, the telephone menu is displayed. The telephone menu offers many options to the user including being able to review and select a telephone number from a log of previous connections; both received and initiated. The user can also choose to store information from the telephone menu, step 13. At step 14, the user is either storing information or initiating a phone call. If the qwerty keyboard is in the open position, unfolded, upon power up then a second menu is displayed, step 15. The device is pre-set to assume that if the keyboard is open at power up then the user is either going to browse the Internet or send a message using a service such as Short Messaging Service (SMS). At step 16, the user selects which service to use. If the user selects Internet, then the mobile browser program is executed, and if the user selects Messaging, then the messaging program is executed, at step 17. In the preferred embodiment, the device is always connected to the Internet and log on is not needed. However, alternative embodiments provide for operating in an environment where the user must log on to the Internet for each session.

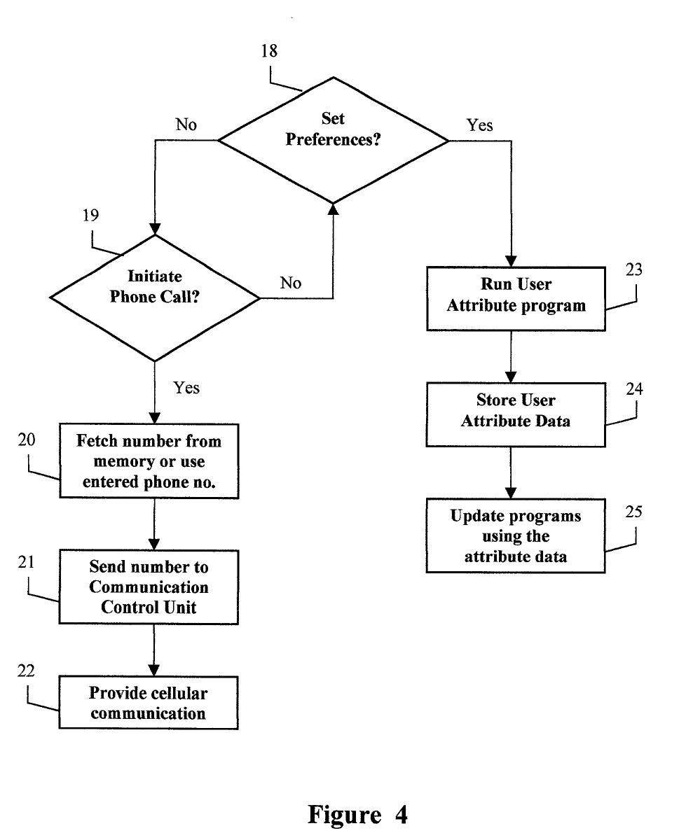

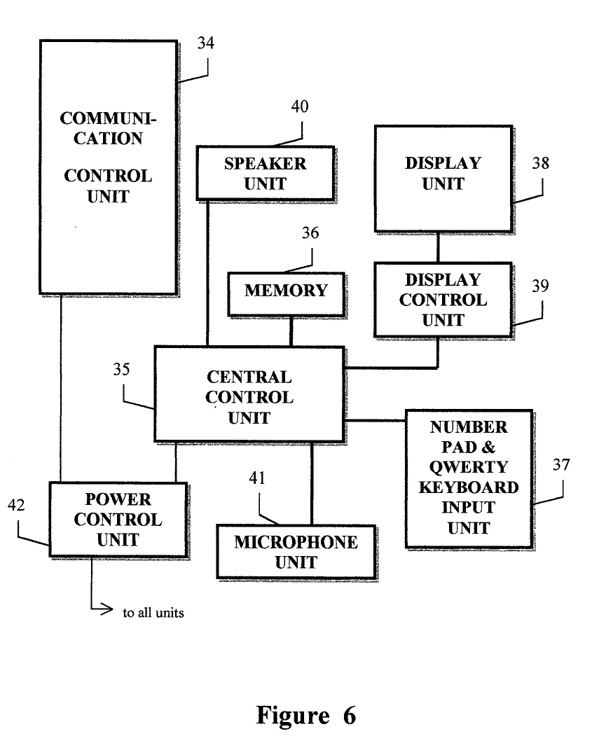

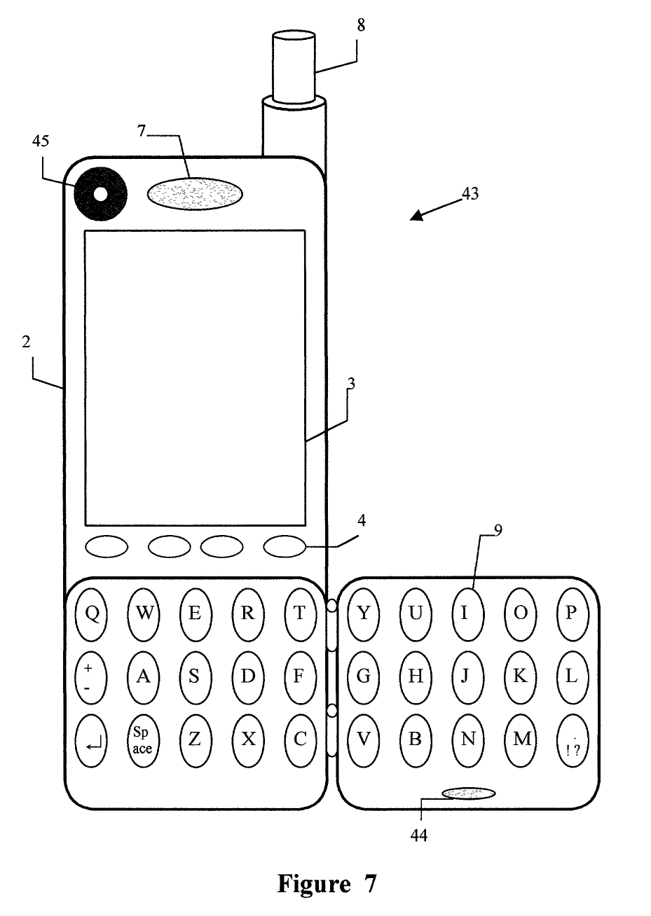

FIG. 4 shows a more detailed flow chart of the device operating in the telephone mode. At step 18, the user can select from the telephone menu to set preferences that include any data related to the user. Alternately the user can initiate a phone call, step 19. If the user initiates a phone call, the device determines which number to call, step 20, and sends the information to the communication control unit, step 21. The number to be dialed is either a previously stored number that was retrieved from memory or it is a number that was entered by the user on number pad 5. The communication control unit, described further in connection with FIG. 6, includes a receiver/transmitter that communicates with the closest cellular antenna, or base station, step 22. If at step 18, the user selected to enter preference data then a menu of attribute programs is displayed, step 23. The user can associate phone numbers, passwords and other data with log on programs and other programs to be executed on the device. At step 24 the user saves the entered data and the device automatically, at step 25, updates the appropriate programs. Users will take advantage of steps 23-25 so that data that is repetitively required by a website or service provider only has to be entered once, thus saving keystrokes.

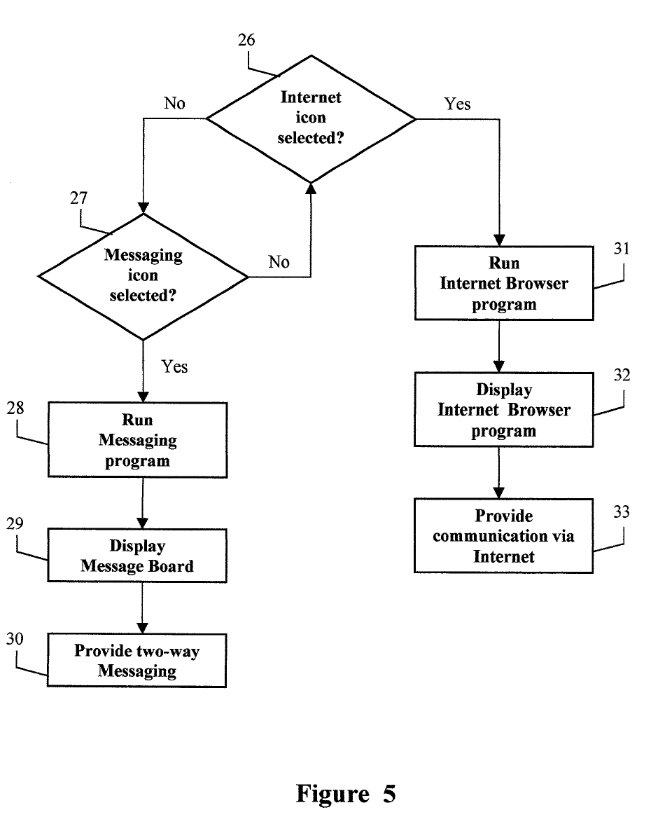

FIG. 5 shows a more detailed flow chart of the device 1 operating in the Internet/Messaging mode. The Internet/Messaging menu includes an Internet icon and a Messaging icon. Step 26 indicates the Internet option is available to the user. Step 27 shows the user may also select the Messaging icon. If the user selects the Messaging icon, the messaging program is run at step 28. A message board is then displayed prompting the user for input, step 29. The device then provides two way messaging so that the user can receive and send messages, step 30. If at step 26, the user selected the Internet icon, the Internet browser program would be run, step 31. The browser is then displayed for the user, step 32, and the user is free to browse the available Internet sites, step 33. Device 1 includes user interface software for each input and output device and may include software that is directed toward making the data entry easy and efficient such as Pocket Word and Pocket Excel.

The present device is intended to ease the typing burden on users that take advantage of cost efficient messaging services such as SMS. The Short Message Service (SMS) is the ability to send and receive text messages to and from mobile telephones. The text can comprise of words or numbers or an alphanumeric combination. SMS was created as part of the GSM Phase 1 standard. Each short message is up to 160 characters in length when Latin alphabets are used, and 70 characters in length when non-Latin alphabets such as Arabic and Chinese are used.

In operation, a network operator launches SMS Mobile Originate, software executed at base stations, to give customer true two-way SMS capability. Customers experiment with the service and work out new uses for it. Addition of a wireless Internet/mobile email service often follows, typically with the customer's mobile number becoming part of the email address they are allocated as part of the service. Emails sent to that address are forwarded as a short message to their wireless phone. Such a service tends to be popular with customers that don't already have an email address. Other information services are available. These services typically start with mainstream content such as news, travel, weather and sports.

Because simple person to person messaging is such an important component of total SMS traffic volumes, anything that simplifies message generation is an important enabler of SMS. Predictive text input algorithms such as T9 from Tegic that anticipate which word the user is trying to generate significantly reduce the number of key strokes that need to be made to input a message. These predictive text algorithms support multiple languages. Predictive algorithms are provided in preferred embodiments of the present invention and may be operational in both the open and closed positions.

The introduction of standardized protocols such as SIM Application Toolkit and the Wireless Application Protocol (WAP) have contributed to an increase in messaging usage by providing a standard service development and deployment environment for application developers and business partners. These protocols also make it easier for users to reply to and otherwise access messaging services through the provision of custom menus on the phone. The introduction of more friendly and easy to use terminals, such as device 1, will contribute to increases in messaging usage by providing simpler access to messaging services.

Mobile phone users sometimes prefer to communicate with each other using the Short Message Service. Typically, such person to person messaging is used to say hello or prompt someone for information or arrange a meeting or passs on some information. Such messages are usually originated from the mobile phone keypad. When the information to be communicated is short or it would take too long to have a full conversation or someone is traveling overseas or not available to take a voice call, SMS is an ideal messaging medium. For example, network operators typically charge the same to send a short message to someone in the same room as they do to someone traveling overseas with their mobile phone.

Because short messages are proactively delivered to mobile phones that are typically kept in the user's pocket and can be stored for later reference, SMS is often more convenient than email to communicate amongst distributed and mobile groups of people. Once users have familiarized themselves with reading and sending short messages, they often find that SMS is a useful way of exchanging information and keeping in touch with friends. This is particularly so when the recipient is also able to reply to messages for two-way communication. Simple person to person messaging generates a high volume of short messages. The most common use of SMS is for notifying mobile phone users that they have new voice or fax mail messages waiting. This is therefore the starting point for most mobile network operators and the first time that mobile phone users use SMS.

Whenever a new message is dispatched into the mailbox, an alert by SMS informs the user of this fact. Because SMS is already routinely used to alert users of new voice mail messages, this application is and will remain one of the largest generators of short messages. Unified messaging is an emerging value-added network service that is particularly compelling because it elevates communication above the technology used to communicate; the message takes precedence over the media. The traditional message collection method is difficult to manage considering all of the different kinds of messages that people get; users have to log-on and pick up emails, pick up their faxes from the fax machine, call in and listen to voice mail and so on. Unified messaging involves providing a single interface for people to access the various different kinds of messaging they use such as fax, voice mail, short messages, and email. Now all of these types of messages can be conveniently accessed from a single point in the most actionable form. The user typically receives a short message notifying them that they have a new message in their unified messaging box. The short message often also includes an indication of the type of new message that has been deposited, such as fax, email or voice mail.

Unified messaging is a convenient application that is likely to become mainstream in the future. It should therefore be a significant generator of short messages as more services are launched. Upon receiving a new email in their mailbox, most Internet email users do not get notified of this fact. They have to dial in speculatively and periodically to check their mailbox contents. However, by linking Internet email with SMS, users can be notified whenever a new email is received. The Internet email alert is provided in the form of a short message that typically details the sender of the email, the subject field and first few words of the email message. Most of the mobile Internet email solutions incorporate filtering, such that users are only notified of certain messages with user-defined keywords in the subject field or from certain senders. Users could find it expensive or inconvenient to be alerted about every email they receive (including unsolicited “spam” emails), which would reduce the value of the service. Because of the high and increasing usage of Internet email to communicate globally, and the benefit from using SMS to notify mobile users about important new email messages, this is likely to be a fast growing and popular application for SMS.

Another emerging SMS-based application is downloading ringtones. Ringtones are the tunes that the phone plays when someone calls it. With the same phone often sold with the same default tune, it is important for phone users to be able to change their ringtone to distinguish it from others. Phones often come with a range of different ringtones built into the phone's memory that the users can choose from. However, it has become popular to download new ringtones from an Internet site to the phone—these phones tend to be popular television or film theme tunes. Ringtone composers are also popular because they allow mobile phone users to compose their own unique ringtones and download them to their phones.

The Short Message Service can be used to deliver a wide range of information to mobile phone users from share prices, sports scores, weather, flight information, news headlines, lottery results, jokes to horoscopes. Essentially, any information that fits into a short message can be delivered by SMS. Information services can therefore be configured as push-based and from a public or private source or pull-based and from a public or private source. An information service for an affinity program may combine public information such as share prices with private information from bank databases. Successful information services should be simple to use, timely, personalized and localized.

Electronic commerce applications involve using an electrical device such as a mobile phone for financial transaction purposes. This usually means making a payment for goods or transferring funds electronically. Transferring money between accounts and paying for purchases are extremely popular electronic commerce applications. The convenience of paying for purchases using SMS must be weighed against the related issues of security, integration with the retail and banking hardware and systems, and money transfer issues. However, this area of electronic commerce applications is expected to contribute significantly to the growing amount of SMS traffic. The cellular telephone embodiment of the present device is tailored toward taking advantage of all of the above features of SMS by providing a full qwerty keyboard for text entry.

FIG. 6, is a schematic block diagram of the hardware provided in a preferred embodiment. Communication control unit 34 comprises a receiver/transmitter, an analog to digital/digital to analog converter, circuitry for voice conversion and burst communications, and the antenna. Communication unit 34 handles all of the radio communications for device 1 and provides support for the American cellular system, including Code Division Multiple Access (CDMA), the European cellular system, GSM. Communication unit 34 receives instructions and data from central control unit 35, which is the brains of the device 1. Central control unit 35 fetches and stores data from and to memory 36 which has the capacity to handle large files such as pictures and video. Central control unit 35 receives user input from number pad and qwerty keyboard input unit 37, display unit 38 via display control unit 39, and microphone unit 41. Text and number data are transmitted from number pad and qwerty keyboard input unit 37. Selected icon and other information selected from display unit 38 are transmitted to the central control unit via display control unit 39. Audio input is transmitted via microphone unit 41. Central control unit sends output to the user over speaker 40, and display unit 38 via display control unit 39. Power control unit 42 receives power from a rechargeable battery and distributes power to the communication control unit 34, central control unit 35, and all other units shown in FIG. 6; not all power connections are shown in order to maintain clarity.

FIG. 7 shows another preferred embodiment in the open position. In this embodiment, the fold out keyboard portion of outer case 2 has a different design in regards to the area included in the fold out section. In this embodiment the entire bottom of the device 43, including the microphone area, folds open. The electrical device 43 has two microphones one on each side of the fold out portion. In the open position microphone 44 is visible and available for use. In the closed position, device 43 has a frontal view similar to FIG. 1 and the user speaks into microphone 6. Camera 45 can be used with either microphone 6 or 44 to provide a video phone wherein the device is used in the hands free mode and the volume to speaker 7 is greatly increased. Camera 45 can also be used to capture still pictures or video for transmission at a later time. All other features of device 43 are similar to those of FIGS. 1 and 2, and have been assigned like reference numbers. Other features that are well known in the art, such sockets or plug adapters for headsets and re-chargers, are included in the preferred embodiment of the present device, and are not discussed further in order to focus on the novel keyboard and functionality of the device.

The foregoing description of the specific embodiments will so fully reveal the general nature of the invention that others can, by applying current knowledge, readily modify and/or adapt for various applications such specific embodiments without departing from the generic concept. For instance, the display screen could be made larger to dominate the front of the device and/or a pointing device could be incorporated to aid data input. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. An electrical device for telephonic and data communications wherein the device is hand held and provides a user with text messaging and voice communications, the device comprising:
a display screen for displaying text and graphical information, such as icons, pictures and video, to the user;
at least one speaker for transmitting audio information, such as voice, to the user;
navigational buttons that control basic functions of the device, such as on/off, initiation and termination of a telephone call, and selection and activation of icons or other data displayed on the display screen;
a number pad that allows the user to input numeric and text data wherein the number pad is a primary input device of telephone number data;
at least one microphone for receiving audio data, such as voice, from the user;
software that provides a graphical user interface for the device and controls operation of hardware provided in the device;
a communication control unit that is part of the hardware provided in the device, the communication control unit providing transmission and reception of voice and text data from and to the device; and,
a fold out section comprising approximately half of a portion of the device underneath the number pad wherein, the fold out section unfolds in a direction perpendicular to a length of the device and further wherein the section unfolds to reveal a full qwerty keyboard contained underneath the number pad, the keyboard being usable with applications on the device and providing the user with easy entry of text data both when a communication channel is open and when no communication channel is open, and
wherein the entire display screen is visible to the user both when the keyboard is in an open position and in a closed position.

2. The device of claim 1, wherein the device is a cellular telephone and the communication control unit includes an antenna that facilitates communication with a cellular base station.

3. The device of claim 1, wherein the device is a portable telephone and the communication control unit includes an antenna that facilitates communication with a portable telephone base that is connected, via a telephone line, to a public switched telephone network.

4. The device of claim 1, wherein the device is capable of using Short Message Service (SMS) and supports the features of SMS.

5. The device of claim 1, wherein the software includes;
an Internet browser that facilitates receiving and inputting data via the Internet; and,
musical software that provides for download and playback of music.

6. The device of claim 1, wherein a first microphone is provided on the number pad and a second microphone is provided on the qwerty keyboard.

7. The device of claim 1, wherein wireless data transmission applications that are compatible with SIM Application Toolkit and Wireless Application Protocol (WAP) are included in the software.

8. The device of claim 1, wherein predictive text software is provided in the software and may be used when the device is in the open and closed positions.

9. The device of claim 1, wherein the device includes a built-in camera for capturing and transmitting pictures and video.

10. A method of providing telephonic and messaging communications capabilities to a user via a hand held electrical device, the method comprising the steps of:
displaying text and graphical information, such as icons, pictures and video, on a display screen of the device;
amplifying audio information, such as voice, through at least one speaker on the device;
providing navigational buttons on the device that control basic functions of the device, such as on/off, initiation and termination of a telephone call, and selection and activation of icons or other data displayed on the display screen;
providing a number pad on the device that allows the user to input numeric and text data wherein the number pad is a primary input device of telephone number data;
receiving audio data, such as voice from the user, in at least one microphone on the device;
loading software that provides a graphical user interface for the device and controls operation of hardware of the device;
controlling transmission and reception of voice and text data from and to the device with a communication control unit of the device; and, providing a fold out section comprising approximately half of a portion of the device underneath the number pad wherein, the fold out section unfolds in a direction perpendicular to a length of the device and further wherein the section unfolds to reveal a full qwerty keyboard contained underneath the number pad, the keyboard being usable with applications on the device and providing the user with easy entry of text data both when a communication channel is open and when no communication channel is open, and wherein the entire display screen is visible to the user both when the keyboard is in an open position and in a closed position.

11. The method of claim 10, wherein the device is a cellular telephone and the communication control unit includes an antenna that facilitates communication with a cellular base station.

12. The method of claim 10, wherein the device is a portable telephone and the communication control unit includes an antenna that facilitates communication with a portable telephone base that is connected, via a telephone line, to a public switched telephone network.

13. The method of claim 10, wherein the device is capable of using Short Message Service (SMS) and supports the features of SMS.

14. The method of claim 10, wherein the software includes: an Internet browser that is capable of receiving and inputting data via the Internet; and, a musical interface program for downloading and playing music.

15. The method of claim 10, wherein a first microphone is provided on the number pad and a second microphone is provided on the qwerty keyboard.

16. The method of claim 10, wherein wireless data transmission applications that are compatible with SIM Application Toolkit and Wireless Application Protocol (WAP) are included in the software.

17. The method of claim 10, wherein predictive text software is provided in the software and may be used when the device is in the open and closed positions.

18. The method of claim 10, further comprising the step of:
providing a camera for capturing pictures and video that can be transmitted from the device.
